(19) United States
(12) Patent Application Publication
(10) Pub. No.: US 2021/0084841 A1
(43) Pub. Date: Mar. 25, 2021

(54) Leaf Collection Assembly

(71) Applicant: Regina Hartgrove, Charlotte, NC (US)

(72) Inventor: Regina Hartgrove, Charlotte, NC (US)

(21) Appl. No.: 16/582,897

(22) Filed: Sep. 25, 2019

(51) Int. Cl. A01G 20/43

(52) U.S. Cl. CPC A01G 20/43

(57) ABSTRACT

A leaf collection assembly for collecting leaves falling from a tree includes a collar that is positionable around a trunk of a tree. A plurality of arms is provided and each of the arms is coupled to and angles upwardly from the collar when the collar is positioned around the trunk of the tree. A screen is attached to the collar and each of the arms such that the screen forms a cone when the collar is positioned around the trunk of the tree. In this way the cone captures leaves falling from the tree. A pair of chutes is provided and each of the chutes is coupled to the collar. Each of the chutes is aligned with the cone to direct the leaves outwardly from the cone for bagging the leaves.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to collection devices and more particularly pertains to a new collection device for collecting leaves falling from a tree.

### BRIEF SUMMARY OF THE INVENTION

An embodiment of the disclosure meets the needs presented above by generally comprising a collar that is positionable around a trunk of a tree. A plurality of arms is provided and each of the arms is coupled to and angles upwardly from the collar when the collar is positioned around the trunk of the tree. A screen is attached to the collar and each of the arms such that the screen forms a cone when the collar is positioned around the trunk of the tree. In this way the cone captures leaves falling from the tree. A pair of chutes is provided and each of the chutes is coupled to the collar. Each of the chutes is aligned with the cone to direct the leaves outwardly from the cone for bagging the leaves.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a leaf collection assembly according to an embodiment of the disclosure.

FIG. 2 is a front view of an embodiment of the disclosure.

FIG. 3 is a bottom view of an embodiment of the disclosure.

FIG. 4 is a top view of an embodiment of the disclosure.

FIG. 5 is a perspective in-use view of an embodiment of the disclosure.

### DETAILED DESCRIPTION OF THE INVENTION

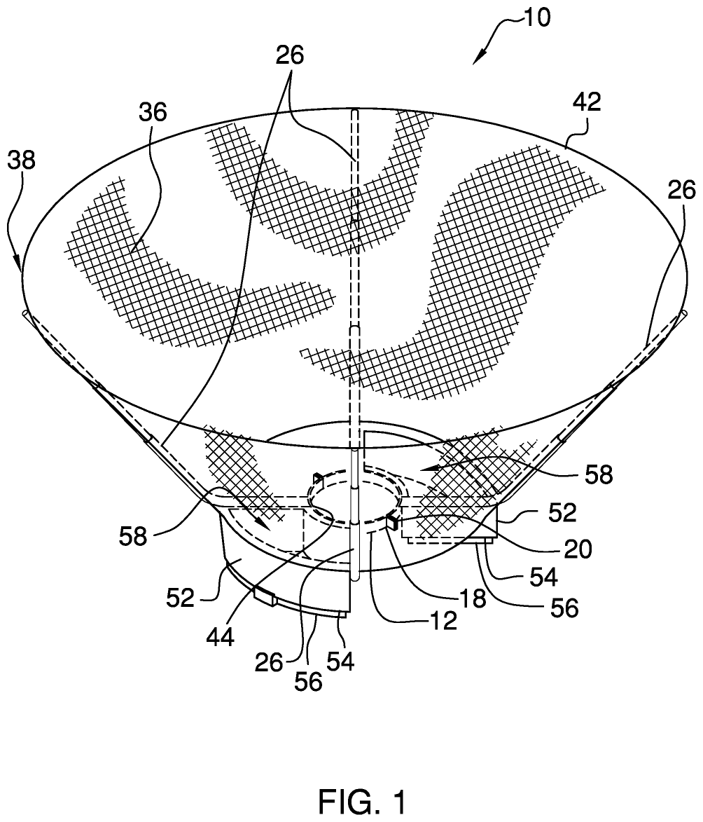

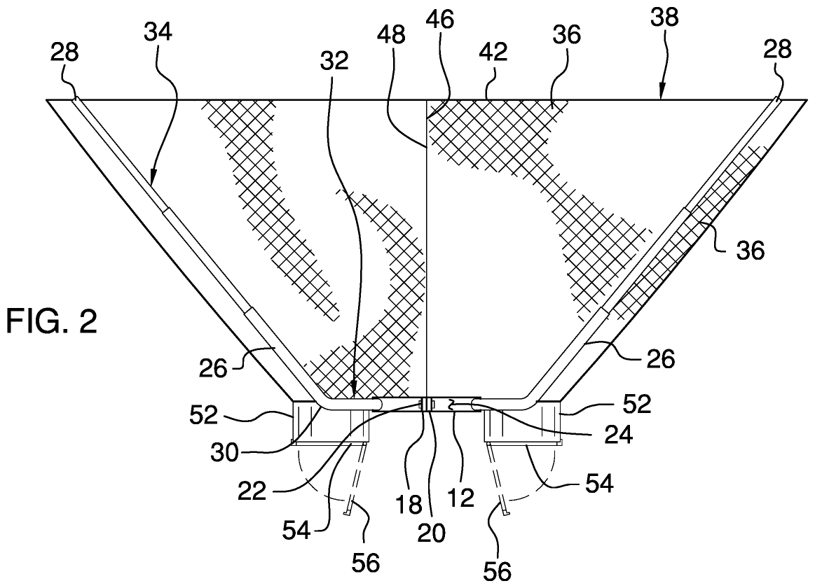

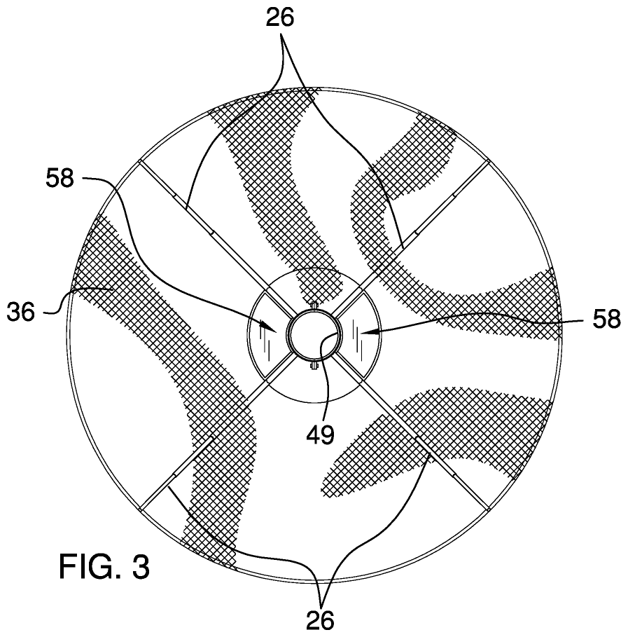

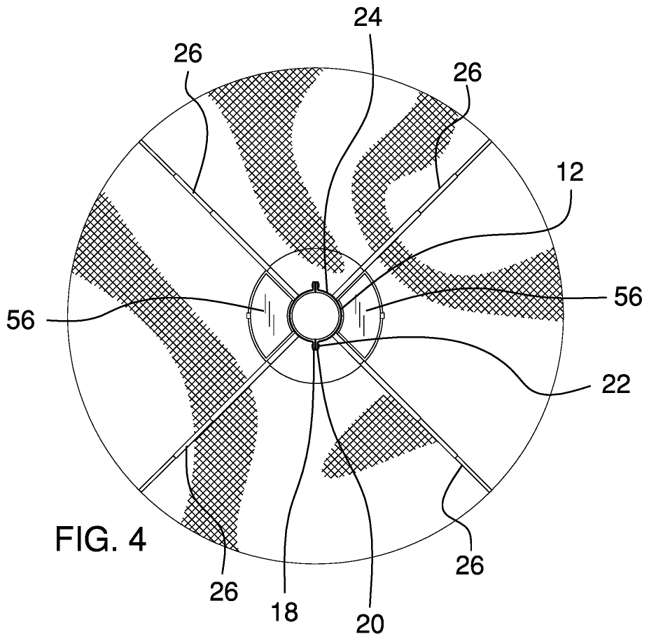

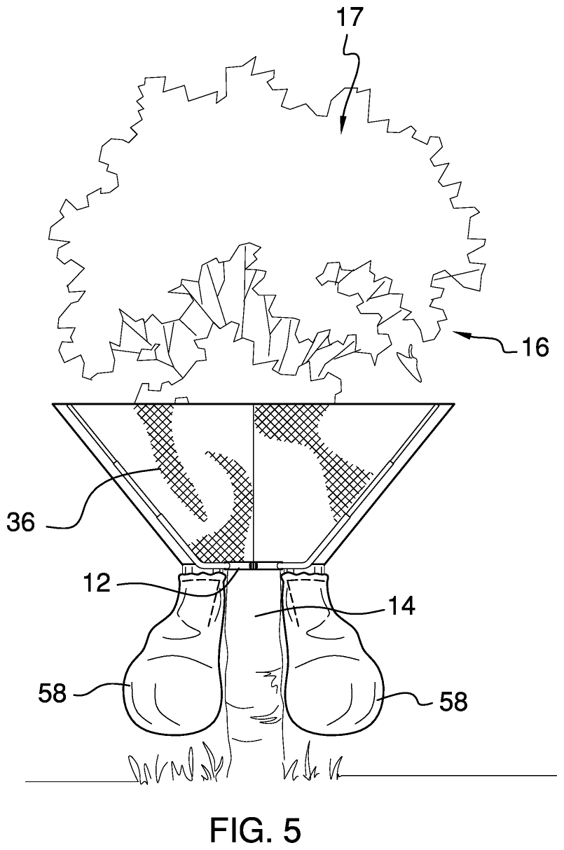

With reference now to the drawings, and in particular to FIGS. 1 through 5 thereof, a new collection device embodying the principles and concepts of an embodiment of the disclosure and generally designated by the reference numeral 10 will be described.

As best illustrated in FIGS. 1 through 5, the leaf collection assembly 10 generally comprises a collar 12 that is positionable around a trunk 14 of a tree 16. The tree 16 may be a deciduous tree of any species that loses its leaves 17 in fall. The collar 12 has a first end 18 and a second end 20, and the first end 18 is spaceable from the second end 20 to facilitate the collar 12 to be positioned around the trunk 14 of the tree 16. Moreover, the first end 18 is matable to the second end 20 such that the collar 12 forms a closed loop to retain the collar 12 around the trunk 14 of the tree 16. The collar 12 may have a first half that is hingedly coupled to a second half, the collar 12 may be comprised of a resiliently bendable material or the collar 12 may be constructed in any way that allows the collar 12 to be opened and closed around the trunk 14. A fastener 22, such as a clamp, a screw and any other releasable fasteners, engages each of the first end 18 and the second end 20 to retain the collar 12 around the trunk 14 of the tree 16. The collar 12 has an outside surface 24 extending between the first end 18 and the second end 20.

A plurality of arms 26 is provided and each of the arms 26 is coupled to and angles upwardly from the collar 12 when the collar 12 is positioned around the trunk 14 of the tree 16. The arms 26 are spaced apart from each other and are distributed around the collar 12. Each of the arms 26 is positioned on the outside surface 24 of the collar 12 and each of the arms 26 has a distal end 28 with respect to the collar 12. Each of the arms 26 has a bend 30 that is positioned between the collar 12 and the distal end 28 to define a first portion 32 forming an angle with a second portion 34 of the arms 26. The first portion 32 of each of the arms 26 is horizontally oriented when the collar 12 is positioned around the trunk 14 of the tree 16. The second portion 34 of each of the arms 26 angles upwardly and outwardly from the collar 12 when the collar 12 is positioned around the trunk 14 of the tree 16. Moreover, the second portion 34 of each of the arms 26 is telescopic such that the second portion 34 of each of the arms 26 has an adjustable length.

A screen 36 is attached to the collar 12 and each of the arms 26 such that the screen 36 forms a cone 38 when the collar 12 is positioned around the trunk 14 of the tree 16. In this way the cone 38 is positioned to capture leaves 17 falling from the tree 16. The screen 36 has a top edge 42, a bottom edge 44, a first lateral edge 46 and a second lateral edge 48. The bottom edge 44 is coupled to the outside surface 24 of the collar 12. The first lateral edge 46 is aligned with the first end 18 of the collar 12 and the second lateral edge 48 is aligned with the second end 20 of the collar 12. Additionally, the first lateral edge 46 abuts the second lateral edge 48 when the collar 12 is positioned around the trunk 14 of the tree 16.

The screen 36 lies on each of the arms 26 and the top edge 42 of the screen 36 is attached to the distal end 28 of each of the arms 26. The second portion 34 of each of the arms 26 may be extendable to a maximum length of approximately 1.5 m. Thus, the distal end 28 of each of the arms 26 defines a point on a circle having a maximum diameter of approximately 5.0 m. In this way the cone 38 is facilitated to have a diameter that is sufficient to extend beneath a full width of the foliage on large, mature trees, such as maple trees, elm trees, oak trees and other large, deciduous trees.

The screen 36 has a plurality of apertures 50 extending therethrough. Each of the apertures 50 is positioned closer to the bottom edge 44 than the top edge 42 of the screen 36. Moreover, each of the apertures 50 is positioned between the first portion 32 of a respective pair of the arms 26. Thus, each of the apertures 50 facilitates the leaves 17 to fall downwardly therethrough for emptying the leaves 17 from the cone 38. The screen 36 may be comprised of a biodegradable material such that the screen 36 decomposes when the screen 36 is discarded.

A pair of chutes 52 is included and each of the chutes 52 is coupled to the collar 12. Each of the chutes 52 is aligned with the cone 38 to direct the leaves 17 outwardly from the cone 38. In this way the leaves 17 that fall into the cone 38 may be collected for bagging or other means of disposal. Each of the chutes 52 is attached to and extends laterally away from the outside surface 24 of the collar 12 and each of the chutes 52 is aligned with a respective one of the apertures 50 in the screen 36. Each of the chutes 52 has a distal end 54 with respect to the cone 38 and the distal end 54 of each of the chutes 52 is open. Moreover, the distal end 54 of each of the chutes 52 is directed downwardly thereby facilitating the leaves 17 to fall downwardly through the chutes 52.

A pair of doors 56 is included, each of the doors 56 is hingedly coupled to a respective one of the chutes 52, and each of the doors 56 is positioned on the distal end 54 of the respective chute 52. Each of the doors 56 is positionable in a closed position to close the respective chute 52 and retain the leaves 17 within the cone 38. Each of the doors 56 is positionable in an open position to open the respective chute 52 and empty the leaves 17 from the cone 38. A pair of bags 58, such as garbage bags or the like, may be coupled to a respective one of the chutes 52 for capturing the leaves 17 that are emptied through the chutes 52.

In use, the first end 18 of the collar 12 is spaced from the second end 20 of the collar 12 and the collar 12 is positioned around the trunk 14 of the tree 16 when fall is approaching. The fastener 22 is manipulated to fasten the collar 12 around the tree 16. Each of the doors 56 is positioned in the closed position and the collar 12 is left on the trunk 14 of the tree 16 until all of the leaves 17 have fallen from the tree 16. The cone 38 captures the leaves 17 as the leaves 17 falls from the tree 16 and the doors 56 are opened when the cone 38 becomes full of leaves 17. Bags 58 are coupled to each of the chutes 52 to capture the leaves 17 prior to opening the doors 56. In this way the leaves 17 are bagged without the need for raking the leaves 17 or otherwise collecting the leaves 17 from the ground. The collar 12 is removed from the tree 16 once all of the leaves 17 have fallen from the tree 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A leaf collection assembly being configured to be positioned around a tree and collecting leaves falling from the tree, said assembly comprising:
a collar being positionable around a trunk of a tree;
a plurality of arms, each of said arms being coupled to and angling upwardly from said collar when said collar is positioned around the trunk of the tree, said arms being spaced apart from each other and being distributed around said collar;
a screen being attached to said collar and each of said arms such that said screen forms a cone when said collar is positioned around the trunk of the tree wherein said cone is configured to capture leaves falling from the tree; and
a pair of chutes, each of said chutes being coupled to said collar having each of said chutes being aligned with said cone wherein each of said chutes is configured to direct the leaves outwardly from said cone for bagging the leaves.

2. The assembly according to claim 1, wherein said collar has a first end and a second end, said first end being spaceable from said second end to facilitate said collar to be positioned around the trunk of the tree, said first end being matable to said second end such that said collar forms a closed loop to retain said collar around the trunk of the tree, said collar having an outside surface extending between said first end and said second end.

3. The assembly according to claim 2, wherein each of said arms is positioned on said outside surface of said collar, each of said arms having a distal end with respect to said collar, each of said arms having a bend thereon being positioned between said collar and said distal end to define a first portion forming an angle with a second portion of said arms, said first portion of each of said arms being horizontally oriented when said collar is positioned around the trunk of the tree, said second portion of each of said arms angling upwardly and outwardly from said collar when said collar is positioned around the trunk of the tree.

4. The assembly according to claim 3, wherein said second portion of each of said arms is telescopic such that said second portion of each of said arms has an adjustable length.

5. The assembly according to claim 3, wherein said screen has a top edge, a bottom edge, a first lateral edge and a second lateral edge, said bottom edge being coupled to said outside surface of said collar having said first lateral edge being aligned with said first end of said collar and having said second lateral edge being aligned with said second end of said collar, said screen lying on each of said arms having said top edge of said screen being attached to said distal end of each of said arms.

6. The assembly according to claim 2, wherein said screen has a top edge, a bottom edge and a plurality of apertures extending therethrough, each of said apertures being positioned closer to said bottom edge than said top edge of said screen wherein each of said apertures is configured to facilitate the leaves to fall downwardly therethrough for emptying the leaves from said cone.

7. The assembly according to claim 6, wherein each of said chutes is attached to said outside surface of said collar, each of said chutes being aligned with a respective one of said apertures in said screen, each of said chutes having a distal end with respect to said cone, said distal end of each of said chutes being open.

8. The assembly according to claim 7, further comprising a pair of doors, each of said doors being hingedly coupled to a respective one of said chutes, each of said doors being positioned on said distal end of said respective chute, each of said doors being positionable in a closed position to close said respective chute wherein each of said doors is configured to retain the leaves within said cone, each of said doors being positionable in an open position to open said respective shoot wherein each of said doors is configured to empty the leaves from said cone.

9. A leaf collection assembly being configured to be positioned around a tree and collecting leaves falling from the tree, said assembly comprising:
a collar being positionable around a trunk of a tree, said collar having a first end and a second end, said first end being spaceable from said second end to facilitate said collar to be positioned around the trunk of the tree, said first end being matable to said second end such that said collar forms a closed loop to retain said collar around the trunk of the tree, said collar having an outside surface extending between said first end and said second end;
a plurality of arms, each of said arms being coupled to and angling upwardly from said collar when said collar is positioned around the trunk of the tree, said arms being spaced apart from each other and being distributed around said collar, each of said arms being positioned on said outside surface of said collar, each of said arms having a distal end with respect to said collar, each of said arms having a bend thereon being positioned between said collar and said distal end to define a first portion forming an angle with a second portion of said arms, said first portion of each of said arms being horizontally oriented when said collar is positioned around the trunk of the tree, said second portion of each of said arms angling upwardly and outwardly from said collar when said collar is positioned around the trunk of the tree, said second portion of each of said arms being telescopic such that said second portion of each of said arms has an adjustable length;
a screen being attached to said collar and each of said arms such that said screen forms a cone when said collar is positioned around the trunk of the tree wherein said cone is configured to capture leaves falling from the tree, said screen having a top edge, a bottom edge, a first lateral edge and a second lateral edge, said bottom edge being coupled to said outside surface of said collar having said first lateral edge being aligned with said first end of said collar and having said second lateral edge being aligned with said second end of said collar, said screen lying on each of said arms having said top edge of said screen being attached to said distal end of each of said arms, said screen having a plurality of apertures extending therethrough, each of said apertures being positioned closer to said bottom edge than said top edge of said screen wherein each of said apertures is configured to facilitate the leaves to fall downwardly therethrough for emptying the leaves from said cone;
a pair of chutes, each of said chutes being coupled to said collar having each of said chutes being aligned with said cone wherein each of said chutes is configured to direct the leaves outwardly from said cone, each of said chutes being attached to said outside surface of said collar, each of said chutes being aligned with a respective one of said apertures in said screen, each of said chutes having a distal end with respect to said cone, said distal end of each of said chutes being open; and
a pair of doors, each of said doors being hingedly coupled to a respective one of said chutes, each of said doors being positioned on said distal end of said respective chute, each of said doors being positionable in a closed position to close said respective chute wherein each of said doors is configured to retain the leaves within said cone, each of said doors being positionable in an open position to open said respective shoot wherein each of said doors is configured to empty the leaves from said cone.
